(19) United States
(12) Patent Application Publication
(10) Pub. No.: US 2014/0150200 A1
(43) Pub. Date: Jun. 5, 2014

(54) WIPER BLADE ADAPTER SYSTEM

(71) Applicants: Koen Bex, Jeuk (BE); Dirk Herinckx, Linter (BE); Helmut Depondt, Kessel-Lo (BE)

(72) Inventors: Koen Bex, Jeuk (BE); Dirk Herinckx, Linter (BE); Helmut Depondt, Kessel-Lo (BE)

(73) Assignee: ROBERT BOSCH GMBH, Stuttgart (DE)

(21) Appl. No.: 14/233,798

(22) PCT Filed: Jul. 6, 2012
(86) PCT No.: PCT/EP2012/063268

§ 371 Date: Jan. 20, 2014

(30) Foreign Application Priority Data
Jul. 20, 2011 (DE) 10 2011 079 470.0

(51) Int. Cl. B60S 1/40

(52) U.S. Cl. CPC B60S 1/4003
USPC 15/250.32

(57) ABSTRACT

The invention relates to a wiper blade adapter system comprising a wiper blade adapter (10) of a jointless wiper blade (12), said adapter being provided for coupling to a wiper arm adapter (14) of at least one first size. The wiper blade adapter system has at least one intermediate adapter (16, 18, 20) that is provided for coupling to the wiper blade adapter (10) and for coupling to a wiper arm adapter (22, 24, 26) of at least one second size.

### TECHNICAL FIELD

A wiper blade adapter system comprising a wiper blade adapter of a jointless wiper blade, said adapter being provided for coupling to a wiper arm adapter of at least one first size, has already been proposed.

### SUMMARY

The invention is based on a wiper blade adapter system comprising a wiper blade adapter of a jointless wiper blade, said adapter being provided for coupling to a wiper arm adapter of at least one first size.

The wiper blade adapter system has at least one intermediate adapter that is provided for coupling to the wiper blade adapter and for coupling to a wiper arm adapter of at least one second size. A wiper blade can thereby be advantageously mounted by means of the wiper blade adapter to wiper arms of different sizes. A “jointless wiper blade” refers in particular to a wiper blade which comprises one or a plurality of in particular curved spring rails and/or particularly comprises a wiper blade rubber that is connected in a jointless manner, in particular via spring rails, to a coupling point, in particular to the wiper blade adapter. A “rigid connection” particularly refers to a connection by means of which the two components, in particular the wiper blade adapter and the wiper blade, are permanently and particularly fixedly connected to one another. In so doing, the two components can be inseparably connected to one another in a non-destructive manner or can be separably connected to one another, for example in a positive-locking manner or in another manner of connection that appears to be useful to the person skilled in the art. “Wiper arm adapter” refers in this context particularly to an adapter which has a contact region with a wiper arm component and is provided to supply a coupling region of the wiper arm component for a coupling and/or contacting to a wiper blade adapter. A “wiper blade adapter” refers in this context particularly to an adapter which has a contact region with a wiper blade component and is permanently connected to the wiper blade component in a disassembled state of a wiper blade from a wiper arm or at least in an operating state and is provided to supply a coupling region of the wiper blade component for a coupling and/or contacting to a wiper arm adapter. An “intermediate adapter” refers particularly to a component which is in contact with both the wiper arm adapter and the wiper blade adapter. “Provided” is understood to mean specially designed and/or equipped.

It is further proposed that the intermediate adapter is intended to enclose the wiper blade adapter in at least two directions. As a result, the intermediate adapter can be especially simply designed. By “enclose in at least two directions”, it is particularly to be understood that the intermediate adapter, in an assembled state, at least partially surrounds and delimits the wiper blade adapter in at least two directions that are different from one another.

In addition, it is proposed that the intermediate adapter is intended to enclose the wiper blade adapter in at least three directions. As a result, the intermediate adapter can be especially advantageously designed, and a particularly advantageous coupling of the intermediate adapter to the wiper blade adapter and the wiper arm adapter can be achieved. By “enclose in at least two directions”, it is particularly to be understood that the intermediate adapter, in an assembled state, at least partially surrounds and delimits the wiper blade adapter in at least three directions that are different from one another, the intermediate adapter being thereby advantageously designed in a U-shaped manner.

It is furthermore proposed that the intermediate adapter has at least one side wall, which forms at least one raised section. In so doing, the intermediate adapter can be especially advantageously designed and have a minimum amount of weight, wherein a width of the intermediate adapter can be especially easily adapted to wiper arm adapters of different size, and in fact particularly by means of raised sections of different size. A “side wall” refers particularly to a wall of the intermediate adapter which extends parallel to a vertical axis and is disposed, particularly in an assembled state, between the wiper blade adapter and the wiper arm adapter. A “vertical axis” refers particularly to an axis which extends orthogonally with respect to a longitudinal axis and orthogonally with respect to a wiping direction. By the term “longitudinal axis”, a direction is particularly to be understood in this context which extends substantially parallel to a longitudinal extension of the wiper blade. A “longitudinal extension” refers in this context particularly to an extension which is a large as possible. By the term “substantially”, in particular a deviation of less than 10°, preferably less than 5°, is to be understood in this context. “Extension” of an element is to be understood in this context particularly as a maximum distance between two points of a vertical projection of the element onto a plane. “Wiping direction” refers in this context particularly to a direction which extends parallel to a surface to be wiped and/or perpendicularly to a main orientation of the wiper strip. A “raised section” refers particularly to a build up of material which sets itself apart from a main body, in particular the side wall, wherein the raised section can have the shape of a strut or a knob or take on another shape that would appear useful to a person skilled in the art.

It is furthermore proposed that the at least one raised section of the at least one side wall is designed as vertical struts. In so doing, the at least one raised section can be particularly advantageously formed. A “vertical strut” refers here particularly to a strut which extends parallel to a vertical axis, i.e. the main extension direction thereof is oriented substantially parallel to the vertical axis.

In addition, it is proposed that the at least one side wall of the intermediate adapter has a receiving area which, in an assembled state, is provided to receive a fastening element. The intermediate adapter can thereby be particularly advantageously coupled to the wiper blade adapter. A “fastening element” refers in this case particularly to an element for connecting two components, such as in particular a screw, a bolt, a pin or another object that appears useful as a connecting element to the person skilled in the art.

It is furthermore proposed that the intermediate adapter comprises at least one central piece which delimits the intermediate adapter in the direction of the wiper arm adapter.

As a result, the intermediate adapter can be particularly advantageously and simply configured in a U-shaped manner.

The invention further proposes that the central piece is formed by three connecting struts which connect the at least one side wall and a further side wall to each other. In so doing, the intermediate adapter can be designed in a simple manner and with a minimum amount of weight. A “connecting strut” thereby refers particularly to a connection between the side walls, which particularly spans a maximum of 60% of a total length of said intermediate adapter, advantageously a maximum of 40% of the total length and most preferably a maximum of 25% of a total length of said intermediate adapter. A “total length” is to be particularly understood as a total expansion of said intermediate adapter along the longitudinal axis.

Moreover, it is proposed that the wiper blade adapter for connecting to the wiper arm adapter has at least one receiving area, which is provided to receive the fastening element. As a result, the wiper blade adapter can be connected to the wiper arm adapter in a particularly advantageous and simple manner.

### BRIEF DESCRIPTION OF THE DRAWINGS

Further advantages ensue from the following description of the drawings. An exemplary embodiment of the invention is depicted in the drawings. The drawings, the description and the claims contain numerous features in combination. The person skilled in the art will expediently consider the features individually and put them together to form further useful combinations.

In the drawings:

FIG. 1 shows a wiper blade system comprising a wiper blade adapter system according to the invention, said wiper blade adapter system having three intermediate adapters according to the invention, and

FIG. 2 shows a wiper blade system comprising a wiper blade adapter system according to the invention.

### DETAILED DESCRIPTION

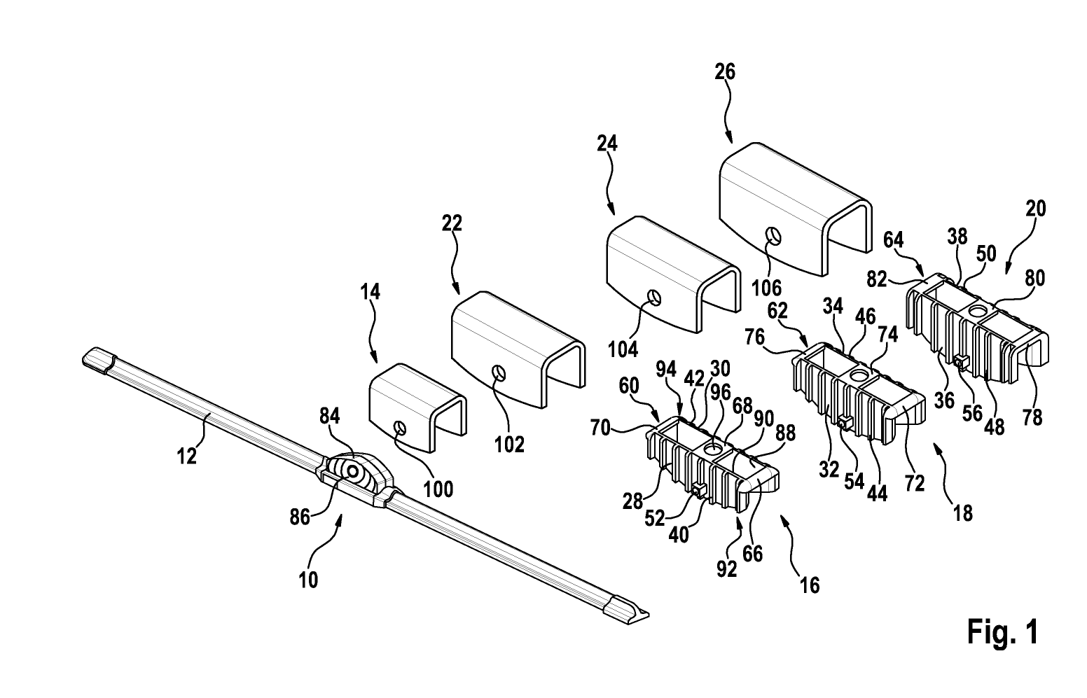

FIG. 1 shows a wiper blade system comprising a wiper blade adapter system according to the invention. The wiper blade system comprises a jointless wiper blade 12. A window pane of a commercial vehicle, which is not depicted in detail, is wiped by means of the wiper blade 12. The jointless wiper blade 12 has an articulation point, which is not depicted in detail. The wiper blade adapter system comprises a wiper blade adapter 10 which is provided for a rigid connection to the jointless wiper blade 12. The wiper blade adapter 10 is fixedly connected via the articulation point of the wiper blade 12 to the jointless wiper blade 12. The wiper blade adapter 10 is thereby connected to the jointless wiper blade 12 in a positive-locking manner. In addition, many further fastening methods, which the person skilled in the art finds useful, are conceivable for fastening the wiper blade adapter 10 to the jointless wiper blade 12d, such as in particular mounting the wiper blade 12 in a guide rail of the wiper blade adapter 10. It is also furthermore conceivable to adhesively bond, screw and/or rivet the jointless wiper blade 12 to the wiper blade adapter 10 if said jointless wiper blade 12 is appropriately designed. If materials are selected appropriately, a welded or soldered connection is in principle conceivable for a rigid connection of the wiper blade 12 to the wiper blade adapter 10. The jointless wiper blade 12 has a main extension direction. A longitudinal axis is oriented in said main extension direction.

The wiper blade adapter 10 comprises an elongated base body 84. A width of the base body 84 is at least substantially equal to a width of the wiper blade 12. A length of the base body 84 which extends along a main extension direction of the wiper blade 12 is substantially larger than the width thereof. Other dimensions are, of course, also in principle conceivable. The wiper blade adapter 10 comprises a receiving area 86 which is provided to receive a fastening element 58. The receiving area 86 is configured as a through-hole and lies orthogonally with respect to the longitudinal axis. The wiper blade adapter 10 can be connected to the wiper arm adapter 14 by means of the receiving area 86 that is configured as a through-hole.

The wiper blade adapter 10 is provided for coupling to the wiper arm adapter 14 of a first size of a commercial vehicle, which is not depicted in detail. The wiper arm adapter 14 is designed in a U-shaped manner. Said wiper arm adapter comprises two receiving holes 100 by means of which the wiper blade adapter 10 can be fastened to the wiper arm adapter 14. In an assembled state, the fastening element 58 is guided through both the receiving area 86 of the wiper blade adapter 10 and the receiving holes 100 of the wiper arm adapter 14 and is fixed with a further fastening element 98 which is designed as a screw nut. As a result, the wiper blade adapter 10 is pivotably mounted via the fastening element 58 to the wiper arm adapter 14. The wiper arm adapter 14 is a part of the commercial vehicle and is fixedly connected to a wiper arm of said commercial vehicle. In so doing, the wiper arm adapter 14 is connected to the wiper arm in a non-destructively detachable manner by means of a connecting method which the person skilled in the art considers useful. In principle, it is also conceivable that the wiper arm adapter 14 is integrally formed with the wiper arm, for example by the wiper arm adapter 14 and the wiper arm being formed in one pour.

Three further wiper arm adapters 22, 24, 26 are shown in FIG. 1 which have a different size than the wiper arm adapter 14. Wiper arms and wiper arm adapters 14, 22, 24, 26 have different sizes for different commercial vehicles. The different wiper arm adapters 14, 22, 24, 26 thereby vary in the length or in the width thereof, in the height thereof and/or in a size of the receiving hole. As a result, it is also in principle conceivable that there are additional wiper arm adapters which are different from the depicted wiper arm adapters 14, 22, 24, 26. The three further wiper arm adapters 22, 24, 26 likewise have in each case two receiving holes 102, 104, 106 by means of which the wiper blade adapter 10 can be fastened to the respective wiper arm adapter 22, 24, 26.

The wiper blade adapter system further comprises an intermediate adapter 16 which is provided for coupling to the wiper blade adapter 10 and to the wiper arm adapter 22 of a second size. The intermediate adapter is configured in a U-shaped manner and thus encloses the wiper blade adapter 10 in an assembled state in three directions. The intermediate adapter 16 has additionally two side walls 28, 30 which are connected to one another by means of a central piece 60 that lies at an angle of 90 degrees to the side walls 28, 30. The side walls 28, 30 are aligned parallel to one another. The side walls 28, 30 have in each case an inner surface 88, 90. A distance at which the side walls 28, 30 are spaced apart from one another, starting in each case from the corresponding inner surface 88, 90, corresponds to the width of the base body 84 of the wiper blade adapter 10 plus a tolerance of approximately 1.0 mm. Hence, the intermediate adapter 16 can be placed over the base body 84 of the wiper blade adapter 10 in an assembly operation. The wiper blade adapter 10 is disposed between the two side walls 28, 30 of the intermediate adapter 16 in the assembled state. In so doing, the inner surfaces 88, 90 of the intermediate adapter 16 rest against a corresponding outer side of the base body 84 of the wiper blade adapter 10.

The side walls 28, 30 form respectively raised sections 40, 42 on the outer side thereof. The raised sections 40, 42 of the side walls 28, 30 are all designed as vertical struts. The raised sections 40, 42 designed as vertical struts extend orthogonally with respect to the longitudinal axis from an end 92 of the intermediate adapter 16 facing the jointless wiper blade 12 in the assembled state up to an end 94 of said intermediate adapter 16 facing away from said jointless wiper blade 12 in the assembled state. Said raised sections 40, 42 designed as vertical struts extend parallel to one another.

The side walls 28, 30 comprise respectively a receiving area 52. The receiving areas 52 are configured as through-holes and are in alignment with one another. The receiving areas 52 are provided to receive the fastening element 58 in the assembled state. In the assembled state, the receiving areas 52 of the sides walls 28, 30 are aligned flush with the receiving area 86 of the wiper blade adapter 10; thus enabling the fastening element 58 to engage in the receiving area 86 of the wiper blade adapter 10 as well as in the receiving areas 52 of the side walls 28, 30.

In an assembled state, the central piece 60 is disposed on the side of the intermediate adapter 16 facing away from the jointless wiper blade 12. The central piece 60 fixedly connects the two side walls 28, 30 to one another. Said central piece 60 is formed from three connecting struts 66, 68, 70. The connecting struts 66, 68, 70 connect the side walls 28, 30 to one another. The intermediate adapter 16 has respectively one end 92, 94 along the longitudinal axis. In so doing, a connecting strut 66, 70 is disposed on one of the ends 92, 94 of the intermediate adapter 16. The connecting strut 68 is equally spaced apart from both the connecting struts 66, 70. The connecting strut 68 is disposed centrally in the intermediate adapter 16 with respect to the longitudinal axis. The centrally disposed connecting strut 68 comprises a recess 96. The recess 96 is of circular design. The recess 96 of circular design is provided to receive a fastening element with which a wiper arm adapter that is not depicted in detail is connected to a wiper arm.

In principle, intermediate adapters 18, 20 are designed identically as the intermediate adapter 16. The intermediate adapters 18, 20 are provided for coupling to the wiper blade adapter 10 and respectively to a wiper arm adapter 24, 26 of a further size. Side walls 32, 34, 36, 38 of the intermediate adapters 18, 20 are spaced apart from one another at the same distance as the side walls of the intermediate adapter 16, whereby a coupling to the wiper blade adapter 10 is ensured. Central pieces 62, 64 of the intermediate adapters 18, 20 are basically configured identically to the central piece 60 of the intermediate adapter 16. As a result, it is in principle conceivable that connecting struts 72, 74, 76 of the central piece 62 of the intermediate adapter 18 and/or connecting struts 78, 80, 82 of the central piece 64 of the intermediate adapter 20 have other widths and heights than the connecting struts 66, 68, 70 of the intermediate adapter 16. The side walls 32, 34, 36, 38 likewise form raised sections 44, 46, 48, 50, which are applied in each case to an outer side of said side walls 32, 34, 36, 38. The raised sections 44, 46, 48, 50 are designed as vertical struts. In order to adapt to the different sizes of the wiper arm adapter 24, 26, the raised sections 44, 46, 48, 50 of the intermediate adapters 18, 20, which raised sections are designed as vertical struts, are configured larger. As a result, a distance from an end of the raised sections 44, 46, 48, 50 to the outer side of the corresponding side wall 32, 34, 36, 38 varies. In addition, receiving areas 54, 56 of the intermediate adapters 18, 20 for receiving the fastening element 58 can have different diameters.

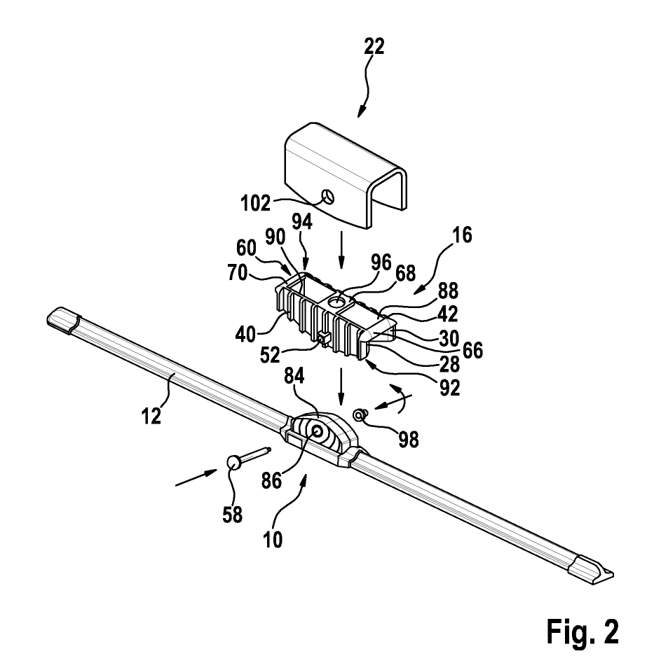

FIG. 2 shows a wiper blade system comprising the inventive wiper blade adapter system in an exploded view. The jointless wiper blade 12 is to be mounted by means of the wiper blade adapter 10 thereof to the wiper arm adapter 22. Because dimensions of the wiper arm adapter 22 are too large for the wiper blade adapter 10, the intermediate adapter 16 is placed between the wiper blade adapter 10 and the wiper arm adapter 22. The intermediate adapter 16 is placed onto the wiper blade adapter 10 such that the receiving area 52 of the intermediate adapter 16 aligns with the receiving area 86 of the wiper blade adapter 10. In so doing, the inner surfaces 88, 90 of the intermediate adapter 16 rest against the outer surfaces of the wiper blade adapter 10. The wiper arm adapter 22 is placed onto the intermediate adapter 16. Inner sides of the wiper arm adapter 22 rest against the raised sections 40, 42 of the intermediate adapter 16. The receiving holes 102 of the wiper arm adapter 22 are aligned flush with the receiving area 52 of the intermediate adapter 16 and the receiving area 86 of the wiper blade adapter 10. The fastening element 58, which is embodied as a screw, is pushed through the receiving holes 102 of the wiper arm adapter 22, whereby the wiper blade adapter 10 and the intermediate adapter 16 are likewise received. The fastening element 58 designed as a screw nut is screwed onto an end of the fastening element 58 designed as a screw, whereby the wiper arm adapter 22 is undetachably connected to the wiper blade adapter 10 and consequently to the wiper blade 12. An assembly of the wiper blade 12 comprising the wiper blade adapter 10 thereof to the additional wiper arm adapters 24, 26 takes place by means of the corresponding intermediate adapter 18, 20 identically to the assembly described above. An assembly of the wiper blade adapter 10 to additional wiper arm adapters can take place by means of additional intermediate adapters adapted in the size thereof.

1. A wiper blade adapter system comprising a wiper blade adapter (10) of a jointless wiper blade (12), said adapter being configured to be coupled to a wiper arm adapter (14) of at least one first size, characterized by at least one intermediate adapter (16, 18, 20) that is configured to be coupled to the wiper blade adapter (10) and is configured to be coupled to a wiper arm adapter (22, 24, 26) of at least one second size.

2. The wiper blade adapter system according to claim 1, characterized in that the intermediate adapter (16, 18, 20), when coupled to the wiper blade adapter, encloses the wiper blade adapter (10) in at least two directions.

3. The wiper blade adapter system according to claim 1, characterized in that the intermediate adapter (16, 18, 20), when coupled to the wiper blade adapter, encloses the wiper blade adapter (10) in at least three directions.

4. The wiper blade adapter system according to claim 1, characterized in that the intermediate adapter (16, 18, 20) has at least one side wall (28, 30, 32, 34, 36, 38) which forms at least one raised section (40, 42, 44, 46, 48, 50).

5. The wiper blade adapter system according to claim 4, characterized in that the at least one raised section (40, 42, 44, 46, 48, 50) of the at least one side wall (28, 30, 32, 34, 36, 38) is designed as vertical struts.

6. The wiper blade adapter system at least according to claim 4, characterized in that the at least one side wall (28, 32, 36) of the intermediate adapter (16, 18, 20) comprises a receiving area (52, 54, 56) which, in an assembled state, is provided to receive a fastening element (58).

7. The wiper blade adapter system according to claim 1, characterized in that the intermediate adapter (16, 18, 20) has at least one central piece (60, 62, 64) which delimits said intermediate adapter (16, 18, 20) in a direction of the wiper arm adapter (22, 24, 26).

8. The wiper blade adapter system according to claim 7, characterized in that the central piece (60, 62, 64) is formed by three connecting struts (66, 68, 70, 72, 74, 76, 78, 80, 82) which connect the at least one side wall (28, 32, 36) and a further side wall (30, 34, 38) of the intermediate adapter (16, 18, 20) to one another.

9. The wiper blade adapter system according to claim 6, characterized in that the wiper blade adapter (10) for connecting to the wiper arm adapter (14) comprises at least one receiving area (86) which is configured to receive the fastening element (58).

10. An intermediate adapter (16, 18, 20) of a wiper blade adapter system according to claim 1.

11. A wiper blade system comprising a jointless wiper blade (12) and comprising a wiper blade adapter system according to claim 1.
